(19) United States
(12) Patent Application Publication
(10) Pub. No.: US 2025/0128184 A1
(43) Pub. Date: Apr. 24, 2025

(54) EQUIPMENT METHOD AND SYSTEM FOR RECOVERING MINERALS FROM ORES WASTE SLUDGE MINING RESIDUES OR ANY OTHER GRANULATED MATERIAL USING THE LIQUEFACTION EFFECT

(71) Applicant: Fernando BERLINCK DUTRA VAZ, Recife (BR)

(72) Inventor: Fernando BERLINCK DUTRA VAZ, Recife (BR)

(21) Appl. No.: 18/688,289

(22) PCT Filed: Aug. 23, 2022
(86) PCT No.: PCT/BR2022/050329

§ 371 Date: Feb. 29, 2024

(30) Foreign Application Priority Data
Sep. 2, 2021 (BR) 1020210174463

(51) Int. Cl. B01D 11/02; C22B 1/00

(52) U.S. Cl. CPC B01D 11/0261; B01D 11/0288; C22B 1/00

(57) ABSTRACT

The invention applies to the recovery or extraction of any type of mineral or minerals that are present in ore, tailings, sludge, mining waste or in any granular material or mixtures of granular materials and is based on the effect of liquefaction. In a container, receptacle, the granular material or a mixture of granular material is placed, which may or may not already have the extraction solution mixed with it. The mineral extraction solution or a working solution is injected into the bottom of the container and vibrations are applied. These vibrations cause the effect of liquefaction and migration, displacement of the extraction solution to the surface of the mineral filler. As the extraction solution rises, passing through the granular material that contains the mineral of interest, it dissolves the mineral and removes the mineral or minerals of interest from the granular medium. At the same time, the grains of insoluble and dense minerals migrate, moving downwards, forming a layer at the bottom of the container. This layer can be separated from the rest of the granular material and its commercialized ore(s). The liquefaction cycle can be repeated as many times as necessary. Once the extracting solution becomes saturated or the granular medium is depleted of the mineral or minerals of interest, the extracting solution and the granular medium are replaced and the cycle begins again. Once extraction is complete, the extraction solution is used, according to the appropriate methodology, to recover the mineral or minerals of interest dissolved in it and simultaneously recover insoluble ores, also via the effect of liquefaction and the migration of grains denser than the liquid to the container bottom.

### BACKGROUND TECHNICAL FIELD

### Field of Invention

The description generally refers to the field of mineral recovery present in ores, ore concentrates, tailings materials, mining sludge and all types of granular materials that have a mineral of economic interest in their composition. More particularly, this description refers to systems and methods for recovering minerals present in ores, ore concentrates, tailings materials, mining sludge and all types of granular materials using the effect of liquefaction as a way of promoting the displacement of the extracting solution from the bottom of the granular material contained in a receptacle to the surface of the material and in this displacement process, the extracting solution dissolves and removes the mineral or minerals present in the granular material.

### Fundamentals of the Invention

Liquefaction is a known effect in vibrating concrete, in saturated soils during earthquakes, or when people jump in saturated beach sand. Liquefaction can be described as the best accommodation, movement of grains that form a granular medium when subjected to vibrations. By accommodating themselves better, closer to each other, the grains force and expel the liquid that was in the intergranular spaces or was injected into the lower part of a container that contains the granular medium and this liquid, being extractive or a working liquid. Due to the difference in density of the liquid, which is less dense, and the grains, which are more dense, the liquid is forced to rise. If this liquid is a solution extracting one or more minerals of interest, or a working liquid, as this liquid rises, passing through the grains, it will dissolve the mineral or minerals of interest present or making it, facilitating the movement of the grains of interest, so that the smaller and denser ones migrate to the lower layers and the less dense and larger ones to the uppermost layers of the load. The extraction solution or working liquid rises and forms a liquid layer on the surface of the granular material contained within the receptacle. This liquid layer formed by the extraction solution can be reinjected into the bottom of the container to extract more of the mineral or be vacuumed, sucked, allowed to drain or drain from the receptacle. When the extractor solution reaches the saturation or optimum point, it can be replaced with a new amount of extractor solution. When all the mineral of interest has been extracted from the granular material, either by the extraction solution or by the migration of the denser grains to the bottom of the receptacle, this material can be replaced by a new batch of the mineral, sludge, waste or granular material that contains the mineral(s) of interest being extracted. In this way, the extraction of mineral from granular media is done via the effect of liquefaction, using as a source any granular media that can be the mineral, concentrates, sludge and mining waste.

The applicant for this patent submitted an invention patent application (BR 10 2021 004474-8), which requests the protection of “equipment, method and system for reducing moisture in granular materials using the effect of liquefaction, The invention applies to reducing moisture in any type of granular materials that contain any dispersed liquid, dissolved in the intergranular spaces.” In the present application, the effect of liquefaction is used to cause an extracting, neutralizing or complementary solution to move from bottom to top between the grains of the charge of granular material placed inside any receptacle and thus come into contact with the mineral or minerals of interest present in the granular material and extract one or more minerals present, thus being a different technology and application from the first patent application.

Currently, taking the mineral gold as an example, the extraction of gold from the ores that contain it is mostly done through a process called leaching where the extraction solution is dripped onto the top of the pile of ore previously ground and made granular. The extraction solution percolates downward until it reaches a waterproof canvas. The solution is then collected and complementary chemical and metallurgical processes remove the gold from the solution. Thus it is a process that can be described as being done from the top down. There are extraction tanks where the milled ore with gold is deposited and the extraction solution is added and removed, without vibrating the granular medium. The first form of extraction is slow and imprecise, as it is not possible to control how the extraction solution will percolate, leach through the granular medium and whether it will dissolve all the gold or mineral present in the granular medium. The second requires a large amount of extraction solution and a complex system and equipment. In both solutions, part of the mineral is lost in the tailings.

There are several technologies to recover the minerals present in ores, concentrates, sludge and mining tailings. However, none use the effect of liquefaction in their process.

In the solution presented here, the applied work energy aims to cause the effect of liquefaction, which is the best accommodation, arrangement, arrangement of the grains of the material and not the removal of the liquid contained in it. The displacement, rise of the liquid contained in the granular material occurs through the secondary effect generated by the force of gravity and difference in densities, which causes denser materials, grains, to move downwards, while less dense materials, liquids, move upwards, forming a liquid layer on top. Thus, much less work energy is required to carry out the same work, that of extracting minerals by extracting solution and separating it from the granular material. Carrying out the work takes less time and can be done with much larger quantities of material than those used in existing solutions that use metal-mechanical equipment.

### BRIEF DESCRIPTION OF THE DRAWINGS

FIG. 1 presents a perspective view of a possible model of the solution for reducing the recovery of minerals of interest present in granular materials, such as ores, tailings, sludge and mining waste using the liquefaction effect. In (01) we have the container/receptacle, which can have any shape or size, dimensions for placing the granular material that contains the mineral or minerals of interest, in (02) we have the solution for removing the liquid layer formed on top of the load of granular material, during and after vibrations, which can have any form, be carried out by suction, drainage, overflow, etc. in (03) we see the extracting solution intake pipe, (04) we have one of the pumps, in (05) we have the extracting solution recirculation pipe, in (06) we have the vibration generator, in (07) we have the vibration isolators, in (09) we have the saturated extractor solution outlet and in (08) we have the discharge, outlet of the granular material, in (08) we have the solution for removing the saturated extractor solution, in (10) we have the layer liquid formed during and after the application of vibrations to the granular medium (11). In (11) we also have a possible formation of layers that can form due to the different densities and granulometry of the material, after the application of vibrations. In (12) we have the feed solution of the granular material that contains the mineral or minerals of interest to be recovered. The equipment has a series of valves, pumps, sensors, complementary software installed and that allows the control of the circulation of the extraction solution and complementary solutions, the control, activation and shutdown of the different parts of the equipment. All these parts, subsystems, sensors, pumps, valves work and operate hormonally and thus enable the correct functioning of the equipment and systems that make it up.

FIG. 2 presents a sectional view explaining the process of recovering or mining ores, soluble or insoluble, using the effect of liquefaction. In (01) we have the container/receptacle. In (02) we have the system for reinjecting the solutions or working fluid. The solutions (10) can be of 3 or more types, such as extraction, detoxification and neutralization solutions. are injected and recovered according to what the method and process demands. In (03) we have the vibration generation solution. In (04) we have any soluble mineral. In (05) we have any insoluble mineral, which after applying the vibrations, migrates to the bottom of the receptacle/container. In (06) and (07) we have grains of materials with no economic interest in the operation. In (08) and (09) we have the solutions for removing the solutions and working fluid that can be directed to different areas for subsequent treatment and complementary actions necessary to recover the mineral or minerals of interest. In (11) we have the solutions or working fluid located in the intergranular spaces and after the application of vibrations, forming a liquid layer on top of the granular material.

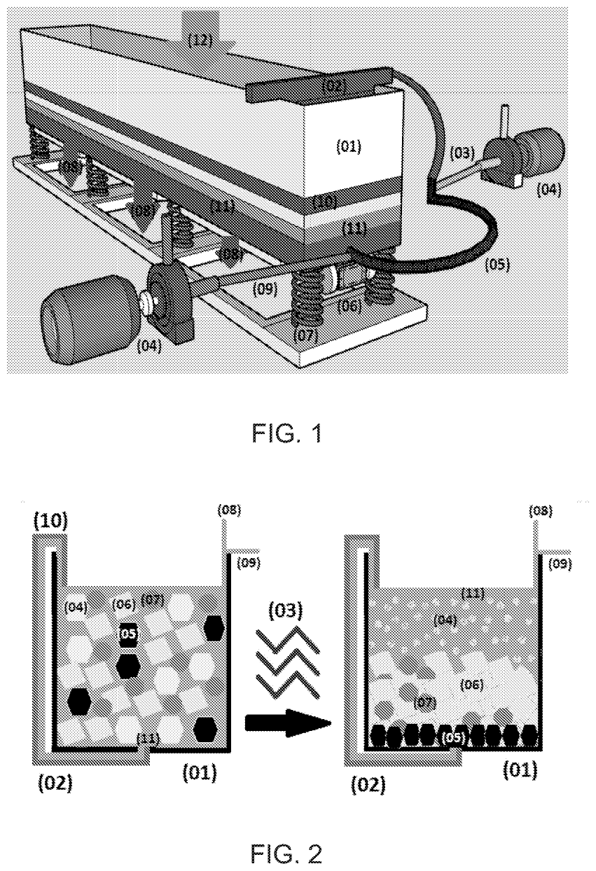

### DESCRIPTION OF THE INVENTION

The equipment, method and system for recovering minerals present in ores, tailings, sludge, mining waste and any granular material using the effect of liquefaction is equipment composed of a container, receptacle of any shape or size. To this receptacle/container is added the granular material containing the mineral or minerals of economic interest to be recovered. The receptacle/container has vibration generating solutions attached, fixed or fixed to it during work. A system adds granular material in advance or as vibrations are generated. An injection and recovery system for the working liquid, extraction solution or complementary, neutralizing, detoxifying solution can be done via forced and/or passive injection at the base of the container/receptacle, or by suction, aspiration, extravasation or any other form/solution that removes the liquid that is the specific or complementary extracting solution, neutralizing for each mineral or minerals that are to be extracted from the granular medium. A solution allows more fresh, unsaturated extractive, supplemental, neutralizing, complementary solution to be injected into the system. A solution allows the extraction solution to saturate without the ability to extract more of the mineral or minerals of interest, to be removed from the system. A solution exists that allows the removal of the granular material that has been added, when the mineral or minerals of interest present in the granular medium have run out or are below the optimum level of system efficiency or economic viability.

The operation of the solution can be described as follows. A granular medium containing the mineral or minerals of economic interest to be extracted is added to the equipment receptacle/container. The system injects the extraction solution or working fluid into the bottom of the receptacle/container load. Vibrations are applied, causing the liquefaction effect. As the extracting solution or working fluid rises, due to the effect of liquefaction, inside, through the granular medium, the solution dissolves the mineral or minerals of economic interest present in the granular medium and causing the grains to dissolve. arrange and migrate according to their densities and granulometry. Upon reaching the top of the granular medium load, the extracting solution or working liquid is removed and can be reinjected or not, depending on its degree of saturation or the need to further separate the grains by density and particle size. The number of reinjection cycles of the extracting solution or a working liquid depends on its saturation and the amount of mineral or minerals of interest still present in the granular medium and its location along the vertical structure of the charge of granular material within the receptacle. When the granular medium has been exhausted or the quantity of the mineral or minerals of interest is so low or the migration of the grains has reached the ideal point that the extraction solution can no longer economically recover the granular medium, having been removed Most of the extraction solution has the part that contains the insoluble mineral of interest recovered and the remainder is discarded and a new batch of the granular medium is added to the receptacle/container and a new extraction cycle restarts. In the case of injecting a working liquid, it can be reused as many times as possible, as it does not undergo chemical, physical or property changes that affect the effect it causes. The equipment allows complementary, neutralizing, detoxifying, removing chemical solutions to be injected into the base of the equipment and undergo the effect of liquefaction passing through the granular material so that the neutralization of acidity or other undesirable characteristics is obtained in order to allow the material granular material is disposed of properly and safely, without impact on the environment. At the same time that vibrations cause different solutions to pass through the granular medium, dissolving and removing mineral or minerals of interest, the second effect of liquefaction causes grains of non-soluble mineral or minerals of interest to migrate to the bottom forming a layer preferably composed of the densest and smallest grains, thus allowing their recovery simultaneously or separately.

### Examples of Embodiments of the Invention

The invention presented here is a solution that, using the effect of liquefaction, makes it possible to extract minerals of economic interest present in any type of granular media. Among the numerous advantages of extracting minerals using the effect of liquefaction, the speed with which the extraction solution passes, migrates from the bottom of the granular medium contained within the receptacle to the top of the granular medium, the capacity of liquid solution to carry out the extraction more efficiently and simultaneously as the vibrations cause impacts between the grains, thus facilitating the removal, dissolution of the minerals of interest present, removes the extracting liquid from the granular material, via the effect of liquefaction, thus reducing the amount of energy to do work. Having the ability to neutralize the acidity or toxicity of the granular medium with injection of neutralizing or complementary solutions at the end or during the extraction process, as required by the extraction of the mineral or minerals. Having the ability to extract one or more minerals from any granular medium and may have extraction steps interspersed with steps of neutralization, alteration or adaptation of the characteristics of the granular medium in order to increase the efficiency of the extraction process. Having the ability to extract soluble and insoluble minerals simultaneously, since liquefaction causes the smaller and denser grains to migrate downwards, forming a layer at the bottom of the receptacle. Have the ability to use one or more already mined granular media, mixed or not, sludge, mining tailings as a source of one or more ores of interest.

1. Equipment, characterized by comprising: a system, method, feeding solution for the granular material (12), a system, removal solution, aspiration, suction overflow (02) of the liquid layer (10) formed after the applications of vibrations with frequencies between more than 0 (zero) and less than 1 Ghz (one Giga Hertz) and powers greater than 0 (zero) watts and less than 1 GW (one Giga Watt), a receptacle (01) that can have any shape, size or capacity, formed by any type of material in its manufacture, being fixed or mobile, being part of another equipment or solution and containing granular material (11), with the receptacle assembly and/or granular material being vibrated by vibration generators (06) and the vibrations generated are isolated from the environment, rest of the equipment by isolators (07), which have an injection system (03) and recirculation (05) with pumps (04) of an extraction solution and a removal system (09) of the extracting solution, with pumps (04), when it reaches saturation and the granular material is removed from the receptacle by a solution (08) of any shape or configuration, it allows dissolving and extracting ore or minerals of interest contained in the granular material that was fed, poured into the equipment and that the extraction is the result of the liquefaction effect of the granular material which ensures that the extraction solution migrates from the lowest part of the receptacle, through the granular material, to the top of the material and, forming a liquid layer. The solution presented here has, as a co-effect of liquefaction, the stratification of the granular material (11) according to its density and granulometry. This co-effect makes it possible to separate different materials that may or may not be soluble, with different densities and/or particle sizes.

2. Equipment, according to claim 1, characterized by the fact that the granular material feeding system can have any configuration, shape or operability, as long as it composes, places the granular load to be vibrated, inside the receptacle, to undergo the effect of liquefaction, form a liquid layer that is removed or recirculated and whether or not this liquid is an extractive solution of ore or minerals present in the granular material or a working liquid, and thus be capable of recovering the ore or minerals of interest present in the granular material via the effect of liquefaction, which after due complementary process using the extracting solution saturated with the ore or minerals of interest as a base, separates the ore or mineral fractions from the extracting solution;

3. Equipment, according to claim 2, characterized by the fact that the injection solution, removal and recirculation of the extracting solution or a working fluid, can have any conformation, design, size to aspirate, suck, let flow, leak, extravasate the liquid layer formed by the solutions or working liquid after applying vibrations to the load of granular material, thus separating the granular material from the solutions that were contained therein and allowing its reinjection, recirculation and removal of the solutions in order to guarantee maximum extraction and economically viable and possible of the ore or minerals, of economic interest, present in the granular material, whether soluble or not;

4. Equipment, according to claim 3, characterized by the fact that the receptacle where the load is deposited can have any configuration, size, dimensions, capacity and be manufactured with any type of material and also be a part of other equipment or solutions that operate integrated;

5. Equipment, according to claim 4, characterized by the fact that the frequency of the applied vibrations can vary between more than 0 (zero) up to 1 GHz and the power of the vibrations can vary between more than 1 Watt up to 1 Giga Watt;

6. Equipment, according to claim 5, characterized by the fact that the vibration generators can be electrical, mechanical, pneumatic, hydraulic, magnetic solutions or any other form that generates vibrations in the receptacle and/or directly in the load contained therein, with objective of creating the effect of liquefaction in the load of granular material containing the ore or minerals of interest;

7. Equipment, according to claim 6, characterized by the fact that it is capable of extracting from a granular material, one or more minerals of interest, reducing the humidity of the granular medium and neutralizing the acidity, toxicity or any other undesirable characteristic resulting from the extraction process or not, but which is present in the granular material at the end of the extraction process and at the same time creates a stratification based on the density and granulometry of the granular materials;

8. Equipment, according to claim 7, characterized by the fact that the extracting solution ca be previously mixed with the granular material or be injected at at the base of the receptacle into which the granular material is poured, it can be of any type, chemical, physical composition, granulometry, densities, whose characteristics allow the liquefaction effect, resulting from the application of vibrations, to cause the extraction solution to migrate from bottom to top, passing through the granular material and forming a layer of the extracting solution on the surface of the granular material, and that complementary and neutralizing solutions are injected subsequently and/or sequentially, thus allowing its removal or recirculation for the purpose of recovering all the ore or minerals present in the granular material, help in the extraction or neutralize, change the characteristics of the granular material; making it less dangerous, toxic or harmful to people and the environment.

9. Equipment, according to claim 8, characterized by the fact that the extraction solution or any other liquid, can be injected and recirculated as many times as necessary in order to guarantee the extraction of the ore or minerals, of interest, present in the granular medium until reach the saturation point and that at the end of the extraction process or having reached the saturation point, the extracting solution can be removed and replaced by a new quantity of unsaturated extracting solution and that the remaining solutions can be injected, in sequence allowing thus its removal or recirculation for the purpose of helping with the extraction or neutralizing, altering the characteristics of the granular material; making it less dangerous, toxic or harmful to people and the environment;

10. Equipment, according to claim 9, characterized by the fact that the granular material can be added to the receptacle of the equipment without the extracting solution or having previously mixed the extracting solution and that the extracting solution moves from the bottom of the receptacle upwards passing by the granular medium in its movement caused by the effect of liquefaction, forming a liquid layer and that the extraction solution can be recirculated, as many times as necessary, in order to guarantee the complete extraction of the ore or minerals present in the granular medium and that when the extracting solution reaches the saturation point, be replaced by a new quantity of fresh, new, non-saturating extracting solution, thus allowing the extraction process to continue until all the ore or minerals of interest have been extracted from the granular material and that when the granular medium is exhausted of the ore or minerals of interest, it is discharged and a new quantity of granular medium is deposited in the receptacle so that the extraction cycle can resume;

11. Equipment, according to claim 10, characterized by the fact that after extracting the ore or minerals of interest from the granular material, this granular material may have its acidity or any other undesirable characteristic neutralized by the injection of a neutralizing solution with any formulation or composition and that this action allows the granular material with reduced humidity to be properly deposited and stored without causing damage to the environment;

12. Equipment, method according to claim 11, characterized by the fact that the extraction of the ore or minerals present in a single granular material or a mixture of granular materials, can be done in a single step or in several sequential steps and that between the extracting steps, other extracting, neutralizing or extraction preparatory solutions, can be injected so that they facilitate or enable the extraction of one or more ores of interest present in the granular material or in the mixture of granular materials and that these can be soluble or insoluble and that its density and particle size can lead to the formation of a layer at the bottom of the equipment, thus allowing its recovery in the solid state;

13. System, method characterized by the fact that it comprises:
a plurality of granular material loading solutions, a plurality of mechanical, magnetic, hydraulic, pneumatic solutions, etc. generation of vibrations with frequencies between above 0 (zero) up to 1 Giga Hertz, with powers above 0 (zero) up to 1 Giga Watt, a plurality of suction solutions, removal, reinjection, recirculation of the liquid layer formed by the extractor solution, of solutions for unloading the granular material with the extraction solution present or not and by a plurality of complementary monitoring solutions, operational sensing of the equipment, method and system that include a plurality of software, electronic circuits, internet of things and sensors and which such a system allows the extraction of ore or minerals present in any form or composition, in the granular medium, whether soluble or insoluble and being recovered dissolved or in solid form through their deposition in the lower part of the receptacle and which the extracting liquid or a working liquid, allows liquefaction to be the form and effect responsible for the recovery of the minerals of interest in soluble or solid form.
